(19) United States
(12) Patent Application Publication
(10) Pub. No.: US 2024/0396424 A1
(43) Pub. Date: Nov. 28, 2024

(54) Controller for a Multi-Phase Power Converter, Multi-Phase Power Converter and Method

(71) Applicant: TDK-Lambda UK Limited, Ilfracombe (GB)

(72) Inventors: Leornard DOBOS, Ilfracombe (GB); Anthony NEW, Ilfracombe (GB)

(21) Appl. No.: 18/670,479

(22) Filed: May 21, 2024

(30) Foreign Application Priority Data
May 23, 2023 (GB) 2307717.5

(51) Int. Cl. H02M 1/00; H02M 1/084; H02M 3/335

(52) U.S. Cl. CPC H02M 1/0043; H02M 1/0009; H02M 1/084; H02M 3/33576

(57) ABSTRACT

A controller (10) for controlling switching in a multiphase power converter (1) having a plurality of converter bridges (2a, 2b), each associated with a phase. The controller (10) includes a driver block (10a) for generating gate driver signals for controlling power switches (HS1-4, LS1-4) in each of the converter bridges (2a, 2b), an imbalance sensor block (10b) for identifying a power imbalance between the plurality of converter bridges (2a, 2b), and an adjustment block (10c) for adjusting the control of the power switches (HS1-4, LS1-4) in response to the detection of a power imbalance by modifying timing of the generated gate driver signals.

### INTRODUCTION

The present disclosure relates to a multi-phase power converter and a controller for controlling switching for driving multiphase converters. The present disclosure is particularly relevant to LLC converters and controllers for controlling switching in a switching topology and, in particular, a half or full bridge topology, and interleaved phases. The present disclosure is particularly useful for two phase converters, where the phases are delayed by 90 degrees, three phase converters, where the phases are shifted 120 degrees, and so on. The disclosure also concerns a method of controlling switching in a multi-phase converter, and a power supply incorporating the switch controller. The disclosure is particularly applicable to variable frequency converters, such as LLC converters.

### BACKGROUND

LLC resonant converters are a type of high-frequency switching converter used in power electronics for converting electrical power. In an LLC resonant converter, there is typically an arrangement of two inductors (L) and one capacitor (C) and power switches arranged in a resonant circuit configuration. The resonant circuit allows for zero voltage and/or current switching of the switches in the converter, reducing switching losses and improving efficiency. LLC resonant converters are commonly used in power electronics for high-efficiency DC-DC conversion and are known for their ability to achieve low electromagnetic interference (EMI) due to their resonant operation.

To increase the power delivered by a power supply, it is possible to arrange several converter bridges connected in parallel within a single power supply. Such multi-phase converters, such as two-phase LLC DC-DC converters have several potential advantages over a single-phase converter. For example, by having multiple phases, the individual magnetics may be smaller and thereby more easily fit into small-height enclosures. At the same time, the resonant currents are also smaller and therefore can be easier to manage on a printed circuit board (PCB). Moreover, in the case of a two-phase converter with a 90 degrees phase delay, the ripple currents partially cancel each other in both the primary and secondary circuits. The ripple frequency is thereby doubled, and the RMS value is much smaller. This makes it much easier to obtain a small ripple voltage at the switching frequency at the output without the need to provide large capacitance.

An issue with multi-phase LLC converters, however, is that in practice they deliver much less power than their theoretical maximum. As such, their performance is limited by other factors and the present invention seeks to address these limitations.

### SUMMARY

According to a first aspect, there is provided a controller for controlling switching in a multiphase power converter having a plurality of converter bridges, each associated with a phase, wherein the controller comprises: a driver block for generating gate driver signals for controlling power switches in each of the converter bridges; an imbalance sensor block for identifying a power imbalance between the plurality of converter bridges; and an adjustment block for adjusting the control of the power switches in response to the detection of a power imbalance.

In this way, the advantage of increasing the power delivered by using multiple phases connected in parallel may be fully realised. At the same time, the controller can load balance the phases output by different converter bridges. For instance, by monitoring the current flowing in each phase of the converter, the controller may control the gate driver signals of the power switches to force sharing the output load between the two phases. That is, the controller may detect which phase delivers more power, and acts on the gate driver signals in the associated converter bridge to alter its behaviour to balance the output load.

In embodiments, the adjustment block is configured to adjust the control of the power switches to modulate the effective time of the voltage gate driver signals. In this way, by using pulse width modulation, the voltage applied to the phase delivering more power can be reduced. That is, the duty cycle for the converter bridge delivering more power can be reduced. For instance, in a two-phase converter, the duty cycle of one of the converter bridges may be reduced below 50%.

In embodiments, the effective time is modulated in the order of hundreds of picoseconds up to hundreds of nanoseconds. Typically, this amount is sufficient to maintain load balance between the two bridges.

In embodiments, the driver block is configured to control the power switches in each of the converter bridges to have predetermined starting phase delay between their respective phases. In this way, the converter may be configured to start with its phases interleaved by a present value. For instance, in a dual phase converter, the phases are delayed by 90 degrees, for a three phase converter, the phases are shifted 120 degrees and so on.

In embodiments, the adjustment block is configured to adjust the phase delay between the phases of the plurality of converter bridges by controlling their respective power switches. In this way, the controller may apply an adjustment to the delay set between the two or more phases of the converter. For instance, in the case of a two-phase converter, where the delay between the two interleaved phases is set at 90 degrees, this will set an adjustment to 90 degrees plus/minus a small correction to balance the output power of each converter bridge. As such, with embodiments of the invention, the adjustment can be performed by varying the relative phase. As such, current balance can be controlled by varying the relative phase shift between phases. This contrasts with methodologies which rely solely on varying the duty cycle (ratio), such as that disclosed in U.S. Pat. No. 5,852,554 and US2016/0028312, that are used for fixed frequency converters. Embodiments of the invention thereby allow adjustment in applications such as variable frequency converters.

In embodiments, the adjustment block is configured to adjust the phase delay in the order of hundreds of picoseconds up to hundreds of nanoseconds. Typically, this amount is sufficient to maintain load balance between the two bridges.

In embodiments, the plurality of converter bridges comprises first and second converter bridges, wherein the driver block is configured to control the power switches in the first and second converter bridges to have a starting phase delay of 90 degrees, and wherein the adjustment block is configured to increase or decrease the starting phase delay based on the identified power imbalance.

In embodiments, the driver block generates gate driver signals for controlling the power switches in one of a half bridge and full-bridge topology for each of the plurality bridge converters.

In embodiments, the plurality of converter bridges are LLC bridges.

In embodiments, the imbalance sensor block identifies a power imbalance based on one or more of: a) identifying a difference between peak primary currents of the plurality of bridge converters; b) identifying a difference between peak secondary currents of the plurality of bridge converters; and c) identifying phase difference between a switching node voltage transition from high voltage to low voltage and a primary side current crossing a zero-amp value. In this way, load imbalances between each converter bridge may be easily identified.

According to second aspect, there is provided a multiphase power converter, comprising: a plurality of converter bridges, each associated with a phase; and a controller according to the above. In this way, a multi-phase converter, such as a two-phase LLC converter, may be provided with improved power output and reliability.

In embodiments, the plurality of converter bridges comprises first and second converter bridges, and wherein the driver block is for controlling the power switches in the first and second converter bridges to have a starting phase delay of 90 degrees, and the adjustment block is for increasing or decreasing the starting phase delay based on the identified power imbalance.

In embodiments, the plurality of converter bridges comprise one of a half bridge and full-bridge topology.

In embodiments, the multiphase power converter further comprises a sensor arrangement connected to the imbalance sensor block, wherein the sensor arrangement is for sensing one or more of: a) a difference between peak primary currents of the plurality of bridge converters; b) a difference between peak secondary currents of the plurality of bridge converters; and c) a phase difference between a switching node voltage transition from high voltage to low voltage and a primary side current crossing a zero-amp value.

In embodiments, the multiphase power converter having a plurality of converter bridges, each associated with a phase, wherein the method comprises: generating gate driver signals for controlling power switches in each of the converter bridges; identifying a power imbalance between the plurality of converter bridges; and adjusting the control of the power switches in response to the detection of a power imbalance.

### BRIEF DESCRIPTION OF DRAWINGS

Illustrative embodiments will now be described with reference to the accompanying drawings in which:

FIG. 1 shows an illustrative two-phase full-bridge LLC converter according to a first embodiment;

FIG. 2 shows an illustrative signal plot of the first and second phase current on the primary and secondary sides;

FIG. 3 shows a schematic illustration of a method of measuring bridge imbalance based on the time delay between switching node voltage and primary side current crossing 0 A;

FIG. 4 is a schematic graph showing the gate signal voltages over two switching periods where phase shift and pulse width modulation control is used for phase load balancing; and

FIG. 5 is a schematic graph showing the gate signal voltages over two switching periods where phase delay control is used for phase load balancing.

### DETAILED DESCRIPTION

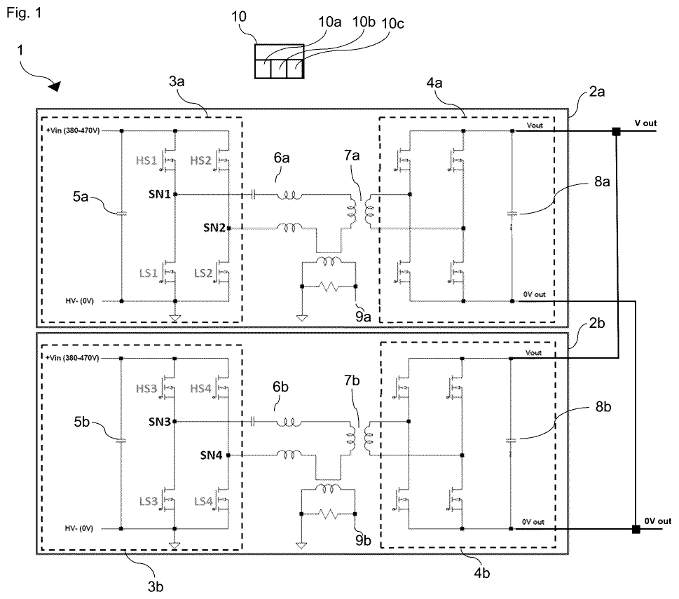

For illustration, a two phases LLC converter 1 is shown in FIG. 1 according to a first embodiment.

The converter 1 comprises a first bridge 2a and a second bridge 2b associated with the first and second phases. Each converter bridge 2a,2b comprises a primary full bridge power switches 3a,3b. In this embodiment, these power switches 3a,3b are provided in a full-bridge topology, although it will be understood that a half-bridge topology may also be used. Each power switch topology is connected to a respective series resonant circuit 6a,6b or resonant tank, and a respective transformer 7a,7b. The transformers connect to respective second synchronous rectifiers 4a,4b. Each primary power switch arrangement 3a,3b comprises a bulk capacitor 5a,5b, and each second synchronous rectifier 4a,4b comprises a smoothing capacitor 8a, 8b. Each bridge also comprises a current sense sub-circuit 9a,9b for current output the sensing from respective primary full bridge power switch 3a,3b.

The converter 1 is driven by controller 10 controlling the gates of the power switch MOSFETS of the first high-side (HS1), first low-side (LS1), the second high-side (HS2), and second low-side (LS2) of the first bridge 2a, and the third high-side (HS3), third low-side (LS3), the fourth high-side (HS4), and fourth low-side (LS4) of the second bridge 2b.

In this respect, the controller 10 implements a software control algorithm which runs on a microcontroller processor within the controller. In other embodiments, the controller 10 may be implemented using a fully integrated solution in an integrated circuit.

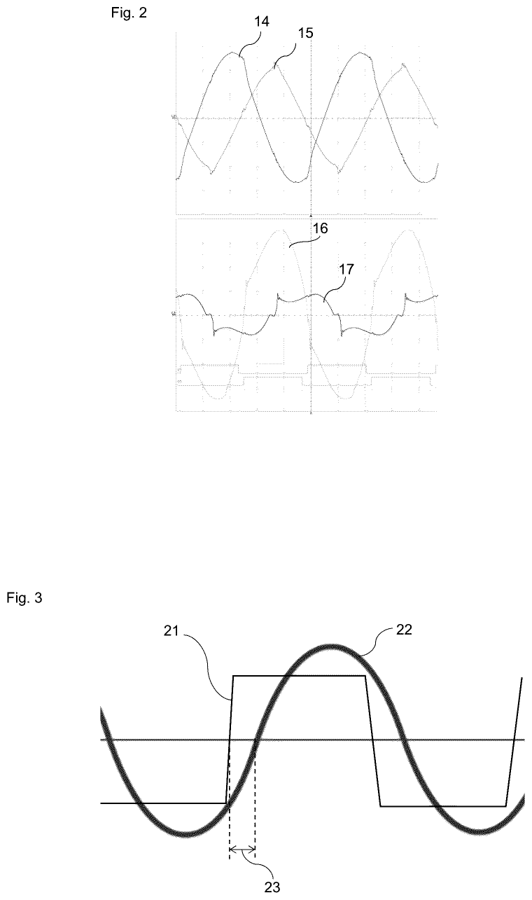

FIG. 2 shows an illustrative example of current measurements at a 30A load for the converter 1 shown in FIG. 1. The upper graph shows the primary side phase 1 signal 15 and primary phase 2 signal 14. The lower graph shows the secondary side phase 1 signal 17 and the secondary side phase 2 signal 14. As such, this indicates that the two phases are not sharing the same current, and consequently they are not delivering the same power. In this example, the second phase 2 shows a higher peak current in both the primary and secondary sides, indicating it is delivering more power. Accordingly, an imbalance has arisen between the first and second bridges 2a,2b.

In this connection, in principle, a two-phase LLC DC-DC converter featuring two identical circuits operated at 90 degrees to each other would have perfect balance between primary currents, and also secondary currents, and the ripple frequency at the secondary would be four times the switching frequency (full-wave rectification is assumed via either half bridge or full bridge rectification using diodes or synchronous rectification using MOSFETs). However, as shown in FIG. 2, real circuits do display imbalance whereby the two phases do not provide equal output current when working under load. This imbalance would prevent the converter 1 from delivering the maximum power the unit was designed for and, ultimately, risks failure of the power components.

The present inventors' investigations have identified that the current/power imbalance has two main causes:
Static Imbalance: The primary resonant circuits in the LLC may not have identical values of capacitance and inductance in each phase;
Dynamic Imbalance: Any static imbalance between phases may be increased by dynamic imbalance, in which one phase hogs current and starves the other.

Static imbalance is mainly caused on the primary side and may affect operation above and below resonance. Dynamic imbalance can occur on primary or secondary but is often evident on the secondary side, especially below resonance.

To address the above, the controller 10 according to the illustrative embodiment functions as a load balance module forcing the two bridges 2a,2b to share the load equally. As is described in further detail below, the controller 10 detects imbalance and, in response, the power switch MOSFETs are controlled to force the balance of the power between the two bridges.

In this respect, the controller's control algorithm includes a plurality of functional blocks for implementing the control method. A driver block 10a generates the gate driver signals, an imbalance sensor block 10b identifies a power imbalance between the plurality of converter bridges 2a,2b, and an adjustment block 10c adjusts the control of the power switches (HS1-4,LS1-4) in response to the detection of a power imbalance. These control methods are explained in further detail below:

### Imbalance Detection

In embodiments, the controller 10 may utilise any signal related to the imbalance of the load between the LLC phases. For example, the following signal may be used to detect the presence of an imbalance:
1. Peak primary current of the two phases
   This has been shown to be related to the output power, and the phase delivering more power, shows a higher peak primary current, as shown in FIG. 2.
2. Peak secondary current of the two phases
   This has been shown to be related to the output power, and the phase delivering more power, shows a higher peak secondary current, as shown in FIG. 2.
3. The phase measurement between the LLC switching node voltage transition from low voltage to high voltage and the primary side current crossing the 0 A value
   FIG. 3 schematically shows this measurement technique where 21 shows the high side gate turning on, and 22 shows the primary current. The time delay 23 between the voltage and current crossing the 0 A value may be used to indicate the phase delay.

A converter according to embodiments of the invention therefore include a sensing circuit for detecting the phase imbalance, with the output of this sensing circuit being fed to the imbalance sensor block 10b. In the embodiment shown in FIG. 1, the current sensing sub-circuits 9a,9b are used to sense the current flowing from the primary side of the first and second bridges to identify the phase delay according to the peak current outlined in method 1 above. In other embodiments, current sense sub-circuits may be provided on the secondary side for implementing method 2 outlined above.

Furthermore, in other embodiments, the current sensing sub-circuits 9a,9b may also be used in combination with a voltage sensor for sensing the delay between the switching node voltage transition for half of the operating voltage and the current on the primary side crossing the 0 A value, as outlined in method 3 above. These signals may be used by the controller in combination with its awareness of the instant of time when the switching devices are turned off and turned on to identify a phase imbalance.

### Balance Control

As mentioned above, the controller 10 implements an adjustment block 10c for adjusting the control of the power switches based on an identified imbalance of the converter bridges 2a,2b. That is, the imbalance is detected as described above and, in response, the controller 10 acts to force the multiphase converter to share the load between the phases, as is described in further detail below.

In this first embodiment, the controller 10 is configured to adjust the gate driving signals for the MOSFET power switches HS1-4 and LS1-4 based on the algorithm output. The controller 10 thereby controls the MOSFETs to force sharing the load between the two phases. The two-control mechanisms, which may be used independently or in combination, are:
1. PWM modulation of the voltage applied to the LLC phase delivering more power; and
2. Adjusting the phase delay between the interleaved phases.

These mechanisms are described in further detail below.

### Phase Shift

Phase may be shift applied to the bridge delivering more power. Phase shift is a control mechanism which delays the gate driving signals of one leg of the full bridge LLC with respect to the other. The effect is a PWM modulation of the voltage applied to the LLC itself. In a half bridge configuration, the PWM modulation is effectively applied to the duty cycle of the two gate driver signals of the half bridge. One will increase its duty cycle, while the second one will reduce its duty cycle. The reduced duty cycle will effectively modulate the frequency of the phase affected by the phase shift.

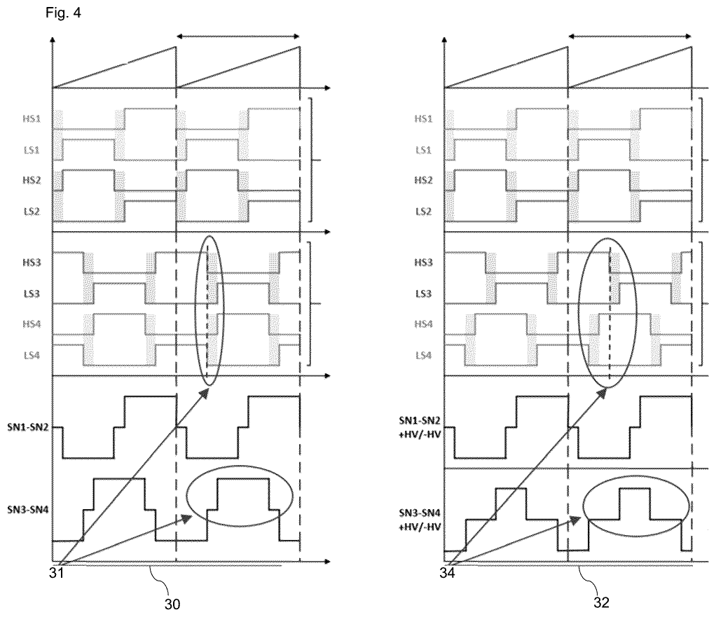

In this respect, FIG. 4 shows a comparison between signals in a conventional converter 30, and the signals in a converter 32 where the controller 10 is implementing phase shift load balancing. As shown in the comparison between pointers 31 and 34, when the load balancing is applied (pointer 34), the second bridge 2b undergoes a phase shift, resulting in pulse width modulation of the SN3-SN4 signals. The phase shift applied may only be a few hundred of picoseconds and a few hundred of nanoseconds, but this amount is sufficient to maintain load balance between the two bridges.

### Phase Delay

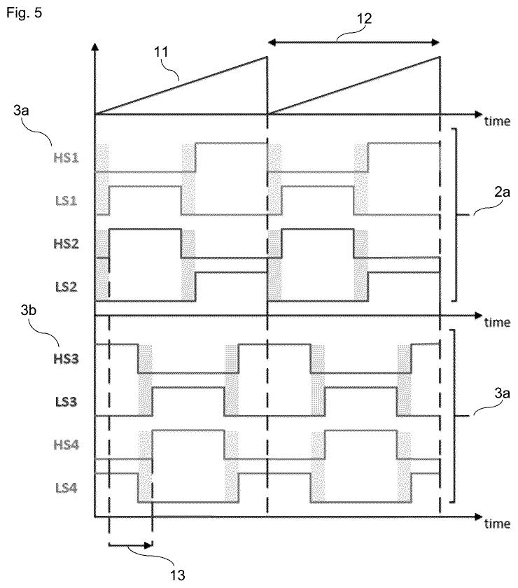

FIG. 5 shows a graph of the gate driver signals used in controlling the two phases LLC converter 1 of FIG. 1. In the figure, two switching periods 12 are shown. A phase delay 13 is applied between the two phases of the LLC converter 1. As this embodiment is a two-phase converter, these phases are delayed by 90 degrees. That is, a delay 13 is achieved by setting 90 degrees of delay in the driving signals of the primary side MOSFETS (HS1-4, LS1-4). However, by adjusting the delay 13 between the two phases, imbalances can be corrected.

In this connection, by changing the 90 degrees delay by a small amount will force the bridge to share the power. This mechanism is more effective below resonance, and it has been related to the ripple voltage in the output and the period of time each bridge delivers power. The LLC delivers power only during the resonant half-cycles; at the resonant frequency, the LLC delivers power for the full period, but below resonant frequency there are short periods when no current is flowing in the secondary circuit and no power is being delivered.

Accordingly, the gate driver signal of one of the bridges may be delayed to create a PWM modulation of the voltage applied to phase shift its phase, thereby reducing its power. This technique is based on the fact that the LLC converter does not transfer energy for the full amount of time when operating below resonance. Changing the delay between the interleaved phases, allows the phase delivering less power, to increase its contribution, using the amount of free time.

In one example, if the LLC resonant frequency is fr=100 KHz and the LLC operates at 100 KHz, the LLC will transfer the energy from primary to secondary side in two half-cycles of 5 μs (½fr). However, if the same LLC operates at 50 KHz, with a half-cycle of 10 μs, the LLC will still deliver energy from primary to secondary side in the same 5 us resonant half-cycles, separated by 5 μs gaps.

In FIG. 2, phase delay is applied above and below resonance, the second bridge 2b is set at 90 degrees phase shift 13 with respect to the first bridge 2a. If the second bridge 2b is delivering more power than the first bridge 2a, the delay is decreased; while if the second bridge 2b is delivering less power than the first bridge 2a, the delay is increased. This adjustment is typically only a few hundreds of nanosecond, but this is sufficient to maintain load balance between the two bridges.

### Summary

Accordingly, the controller 10 takes the phase imbalance sensor information and calculates the amount of phase shift and phase delay to be set between the driving signals of the multiphase LLC converter. This therefore presents a new way to control the switching in a multiphase LLC converter which forces each phase to share the load by controlling the gate signals driving the half bridge or full bridge switching devices.

To detect the imbalance between the phases of the LLC multiphase converter. The controller 10 may use the sensed peak current on the primary side and/or on the secondary side, and/or or the phase between the LLC switching node voltage transition for half voltage and the transition for 0 A of the primary current.

In response, the controller will force the multiphase LLC converter to share the load, by acting on the gate driving signals using the phase shift and/or the phase delay mechanism.

Accordingly, in embodiments of the present invention, the advantage of increasing the power delivered by using multiple phases connected in parallel may be fully realised.

It will be understood that the embodiment described above shows an application only for the purposes of illustration. In practice, embodiments may be applied to many different configurations, the detailed embodiments being straightforward for those skilled in the art to implement.

For example, although the controller and balance method is described above in the context of a two phase LLC in a full bridge configuration, it will be understood that the same approach could be extended to any multiple phase LLC converter, in both full bridge and half bridge configurations.

1. A controller for controlling switching in a multiphase power converter having a plurality of converter bridges, each associated with a phase, wherein the controller comprises:
a driver block for generating gate driver signals for controlling power switches in each of the converter bridges;
an imbalance sensor block for identifying a power imbalance between the plurality of converter bridges; and
an adjustment block for adjusting the control of the power switches in response to the detection of a power imbalance.

2. A controller according to claim 1, wherein the adjustment block is configured to adjust the phase delay between the phases of the plurality of converter bridges by controlling their respective power switches.

3. A controller according to claim 1, wherein the adjustment block is configured to adjust the control of the power switches to modulate the effective time of the voltage gate driver signals.

4. A controller according to claim 3, wherein the effective time is modulated in the order of hundreds of picoseconds up to hundreds of nanoseconds.

5. A controller according to claim 1, wherein the driver block is configured to control the power switches in each of the converter bridges to have predetermined starting phase delay between their respective phases.

6. A controller according to claim 1, wherein the adjustment block is configured to adjust the phase delay in the order of hundreds of picoseconds up to hundreds of nanoseconds.

7. A controller according to claim 1, wherein the plurality of converter bridges comprises first and second converter bridges, wherein the driver block is configured to control the power switches in the first and second converter bridges to have a starting phase delay of 90 degrees, and
wherein the adjustment block is configured to increase or decrease the starting phase delay based on the identified power imbalance.

8. A controller according to claim 1, wherein the driver block generates gate driver signals for controlling the power switches in one of a half bridge and full-bridge topology for each of the plurality bridge converters.

9. A controller according to claim 1, wherein the plurality of converter bridges are LLC bridges.

10. A controller according to claim 1, wherein the imbalance sensor block identifies a power imbalance based on one or more of:
a) identifying a difference between peak primary currents of the plurality of bridge converters;
b) identifying a difference between peak secondary currents of the plurality of bridge converters; and
c) identifying phase difference between a switching node voltage transition from high voltage to low voltage and a primary side current crossing a zero amp value.

11. A multiphase power converter, comprising:
a plurality of converter bridges, each associated with a phase; and
a controller according to claim 1.

12. A multiphase power converter according to claim 11, wherein the plurality of converter bridges comprises first and second converter bridges, and
wherein the driver block is for controlling the power switches in the first and second converter bridges to have a starting phase delay of 90 degrees, and the adjustment block is for increasing or decreasing the starting phase delay based on the identified power imbalance.

13. A multiphase power converter according to claim 11 or 12, wherein the plurality of converter bridges comprise one of a half bridge and full-bridge topology.

14. A multiphase power converter according to claim 11, further comprising a sensor arrangement connected to the imbalance sensor block, wherein the sensor arrangement is for sensing one or more of:
a) a difference between peak primary currents of the plurality of bridge converters;
b) a difference between peak secondary currents of the plurality of bridge converters; and
c) a phase difference between a switching node voltage transition from high voltage to low voltage and a primary side current crossing a zero-amp value.

15. A method for controlling switching in a multiphase power converter having a plurality of converter bridges, each associated with a phase, wherein the method comprises:
generating gate driver signals for controlling power switches in each of the converter bridges;
identifying a power imbalance between the plurality of converter bridges; and
adjusting the control of the power switches in response to the detection of a power imbalance.
